(19) United States
(12) Patent Application Publication
(10) Pub. No.: US 2020/0256309 A1
(43) Pub. Date: Aug. 13, 2020

(54) Deep Water Pressure Electricity Generating Method, Apparatus and System

(71) Applicant: Stephen Tomás Strocchia-Rivera, Rhinebeck, NY (US)

(72) Inventor: Stephen Tomás Strocchia-Rivera, Rhinebeck, NY (US)

(21) Appl. No.: 16/271,836

(22) Filed: Feb. 10, 2019

(51) Int. Cl. F03B 13/10; F03B 11/00

(52) U.S. Cl. CPC F03B 13/10; F03B 11/004

(57) ABSTRACT

A method and device are provided for generating electricity from a body of water including a power generating tube having inside walls, outside walls, a top and an inlet at the bottom. The tube includes a neck comprising an inlet to the bottom and an outlet open at the top. A gate valve blocking the inlet is opened by remote control signals. Alternatively, an explosive plug blocking the inlet is removed by an explosion initiated by a remote control device. The power generating tube loaded with a means for generating electricity and empty of water is installed in the water with the inlet located deep in the water below the top that is positioned above the surface of the water.

### CROSS REFERENCE TO RELATED APPLICATION

This is a continuation in part of U.S. patent application Ser. No. 15/697,486 filed Sep. 7, 2017 of Stephen Tomás Strocchia-Rivera, entitled “Payload Launching Apparatus and Method” which is incorporated herein by reference.

### FIELD OF THE INVENTION

This invention relates to generation of electrical power with deep water pressure from a body of water, and more particularly to generation of electricity with deep water pressure powering a hydro-turbine generator.

### BACKGROUND OF THE INVENTION

A problem with many on-demand power generating systems is that power supply problems may occur due to failure of power generation sources or failure of the power distribution grid. Such failures require solutions such as use of back-up power generation, batteries or hydro-turbine generators driven by water under pressure from dams or tidal currents, or stand-by local fossil fuel powered generators. In addition, there is a problem of emergency situations where there is a need for backup sources of electrical power as in the cases of power failures on ships at sea or on ships anchored at sea or proximate to isolated islands.

In the past, sources of water from high dams has been supplied to produce electric power with hydro-turbine generators driven by water under pressure from by pipes which are inclined downwardly either vertically or at an angle to lower elevations than the water in the dam to supply high pressure water power to a turbine that drives a generator to produce either direct current or alternating current electrical power.

However there are environments where high dams, tidal sources of power generation, and adequate stand-by power sources are unavailable.

Accordingly in remote locations or other places where emergency power supply is required, there is a need for an alternative power generating methods, apparatus and systems with high-pressure water to drive hydro-turbine generators. The apparatus and methods in accordance with this invention allow a large amount of clean potential-energy to be stored in a simple structure.

There is also a need for a cost effective source of energy, when based in the ocean or deep water which has reduced and/or minimal impact on areas occupied by human beings and land based animals.

### BRIEF SUMMARY OF THE INVENTION

The apparatus and methods in accordance with this invention allow easy reuse of the electrical power generating system infrastructure. Moreover, the infrastructure required for generating electricity is less expensive and less complex than is traditional. The apparatus and methods in accordance with this invention allow a large amount of clean potential energy to be stored in a simple structure.

The method apparatus and system in accordance with this invention are cost effective, and have reduced and/or minimal impact on areas occupied by human beings and land based animals, when based in the ocean.

The apparatus and methods in accordance with this invention allow a large amount of potential for generation of clean energy to be available from a simple structure.

In accordance with one aspect of this invention, a cylinder houses a hydroelectric power source comprising a hydro-turbine generator. The cylinder, which is partially submerged in water, is filled with air and empty of water. The power source is employed to generate electricity by harnessing the high pressure of water deep below the surface to drive a generator housed in the cylinder.

In accordance with this invention, a method, system and/or apparatus is provided by an electrical power generating device within a partially submerged air filled tube having a top end extending above a body of water. The submerged bottom of the tube is sealed by a normally-closed flow blocking device which is opened to initiate generation of electricity. The bottom of the tube is anchored to the floor of the body of water.

Preferably a power supply is provided for operating the flow blocking device and to an actuation device.

Preferably the flow blocking device comprises a gate valve and the gate valve is operated by a hydraulic system.

Preferably, power is supplied to the flow blocking device by a cable; and remote control lines connect the actuation device to the flow blocking device.

In accordance with another aspect of this invention a method, apparatus and/or system for generating electrical power from water pressure comprises a power tube having inside walls, outside walls, a top and a bottom; an inlet at the bottom and an outlet open at the top; a flow blocking device comprising a gate valve or a plug at the inlet opened by remote control; and a hydro-turbine electric power generator housed inside the power tube.

Preferably the method, apparatus, and/or system includes an actuation device for sending remote control signals for opening and/or closing of the flow blocking device; the power generating tube being installed in the water with the bottom located deep in the water below the top; and the actuation device being adapted for sending a remote control signal for opening the flow blocking device.

Preferably, the device includes a support secured to inside walls of the power generating tube for supporting a means for generating electricity above the flow blocking device, and means for anchoring the power generating tube in the water. Preferably, the device includes a power supply for the flow blocking device and to the actuation device.

Preferably the flow blocking device comprises a gate valve or an explosive seal/plug.

Preferably, the gate valve is operated by a hydraulic system or electric system.

Preferably, power is supplied to the flow blocking device by a cable; and remote control lines connect the actuation device to the flow blocking device.

### BRIEF DESCRIPTION OF THE DRAWINGS

FIG. 1 is a schematic drawing showing a power generating system in accordance with this invention that is adapted to be immersed in a body of water.

FIGS. 2A and 2B are schematic drawings showing portions of the power generating system of FIG. 1 partially immersed in a body of water and with the power generating system containing a power generating system.

FIG. 3A is a schematic drawing of a plan view of an alternative embodiment of a power generating system in accordance with this invention.

FIG. 3B is a sectional view of the power generating system of FIG. 3A taken along section line 3B-3B of FIG. 3A.

FIG. 4A is a sectional, elevational view of a remote control hydraulic valve system with the gate of the valve shown in the open position and the hydraulic control system depicted schematically.

FIG. 4B is a view taken on line 4B-4B of FIG. 4A showing the gate of the gate valve in the open position.

FIG. 4C is a view of a modification of FIG. 4B showing the gate of the valve in the closed position.

FIG. 5 is a flowchart of the methods in accordance with this invention of operating the devices of FIGS. 2, 3, and 3A/4B that are adapted to be partially immersed in a body of water.

### DETAILED DESCRIPTION OF THE PREFERRED EMBODIMENTS

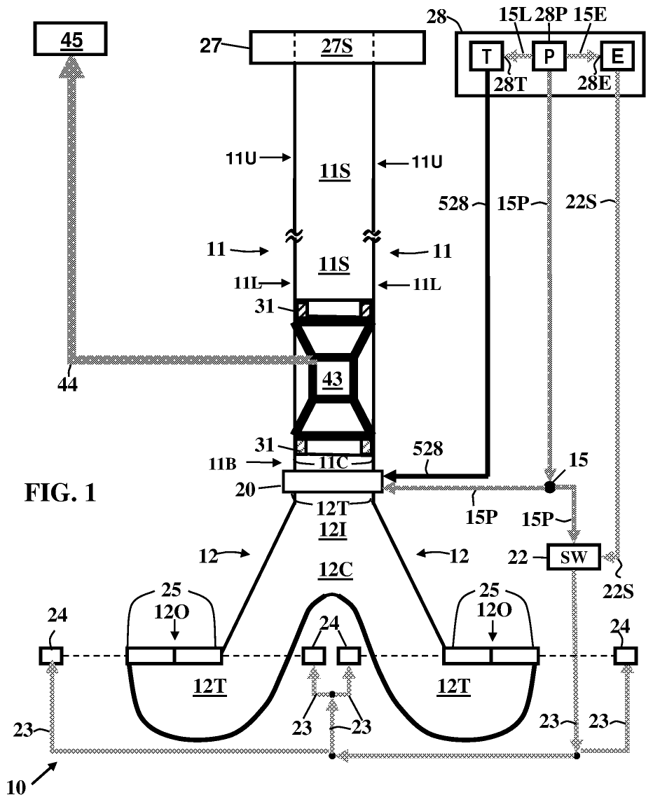

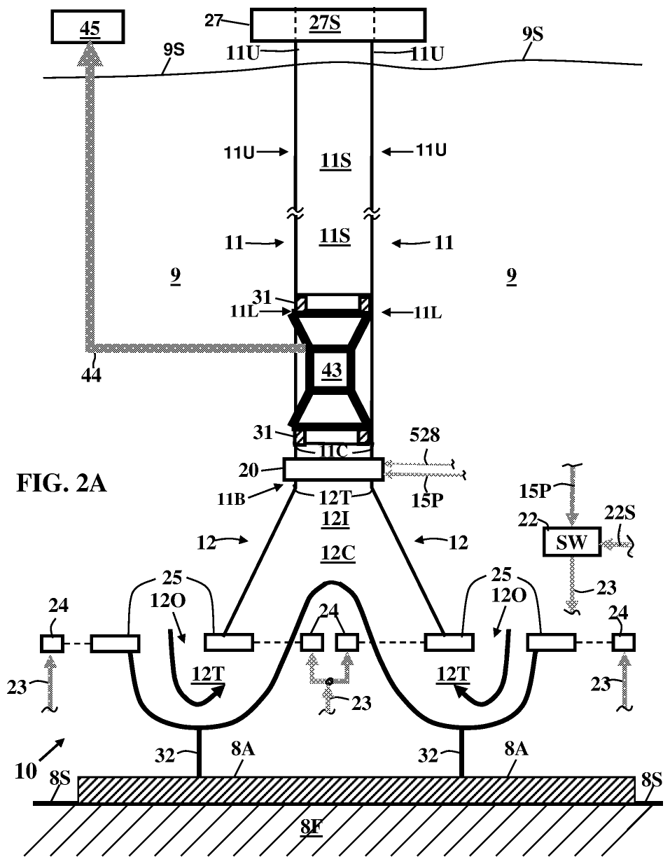

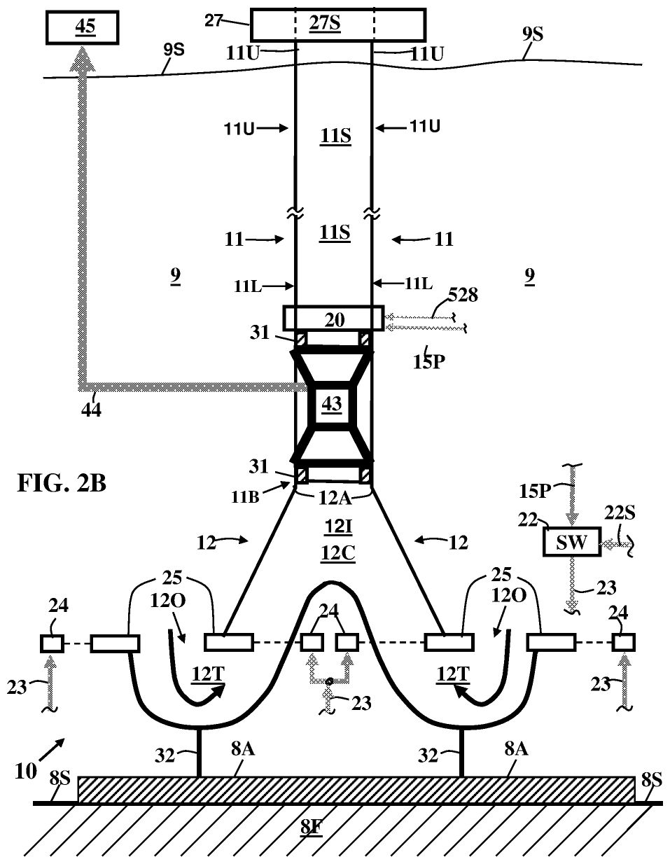

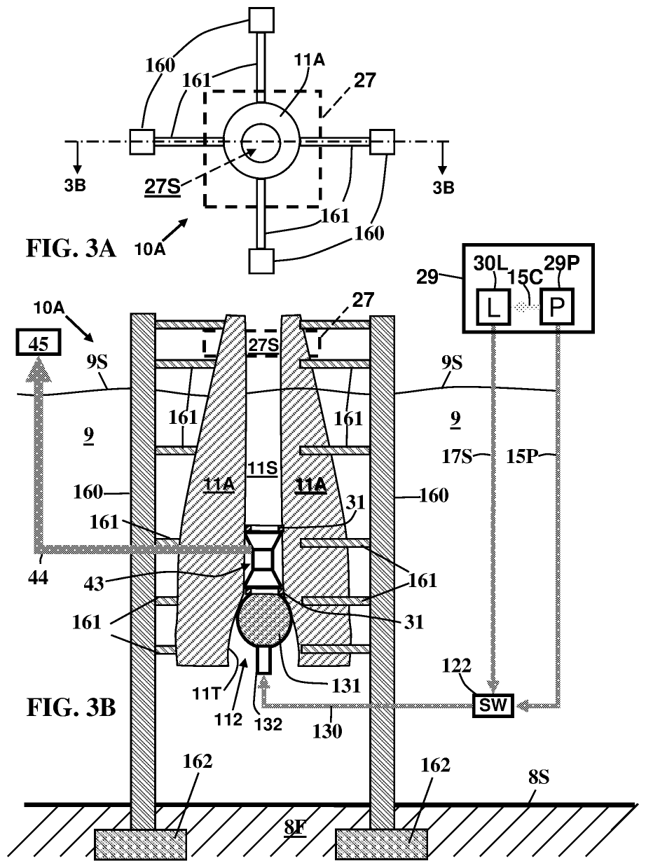

FIGS. 1, 2A, 2B, and 3 show power generating systems 10/10A in accordance with this invention, including a hydro-turbine, electric generator 43 housed in power generating tubes 11/11A. In FIGS. 2A, 2B and 3, the power generating system 10 is shown partially immersed in a body of water 9. As shown the power tubes 11/11A reach up vertically from an inlet 12/112 just above the floor 8F of the body of water 9 to an outlet above the surface 9S of the body of water 9.

When the power tube 11/11A is partially immersed in the body of water 9 water pressure from deep in the water 9 can provide sufficient high water pressure to power the hydro-turbine generator 43 housed in the power generating tubes 11/11A. In FIGS. 2A and 2B the hydro-turbine generator 43 is secured to a support ring flange 31 bonded to the inner wall of the lower segment 11L of the power tube 11.

In FIGS. 1, 2A and 2B high pressure water 9 is to be admitted from the top 12T of a convergent, tubular, nozzle 12 to the bottom 11B of the power tube 11 from deep within the body of water 9 through a convergent, tubular, nozzle 12 and a control valve system 20 as well as a set of optional, lower level, access valve(s) 25 both located well below the power tube 11.

In FIG. 2B, the high pressure water 9 is also admitted to the bottom of the power tube 11 from deep within the body of water 9 through the convergent, tubular, nozzle 12 but directly through the support ring flange 31 to the input of the hydro-turbine generator 43 with the control valve system 20 relocated thereabove. The access valves 25 are shown closed in FIG. 1 and are shown open in FIGS. 2A and 2B.

Similarly in FIG. 3, water 12 under pressure is to be admitted through a neck inlet 112 below tube 11A after an explosive plug 131 is removed by an explosion triggered by remote control. In FIG. 3 the hydro-turbine generator 43 is also secured to a support ring flange 31 bonded to the inner wall of the inlet of the power tube 11A.

Each power tube 11/11A comprises a rigid structure with an internal, hollow, tubular chamber 11S that is aligned with and combined with an internal, hollow, cylindrical, tubular, outlet chamber 27S located above the surface 9S of the water 9.

A central station 28 shown in FIG. 1 includes a power source (P) 28P and an operator toggle device (T) 28T as an actuation device which provides remote control signals on line 528 to operate the control valve system 20 at the bottom 11B of the power tube 11 in FIGS. 1, 2A and 2B.

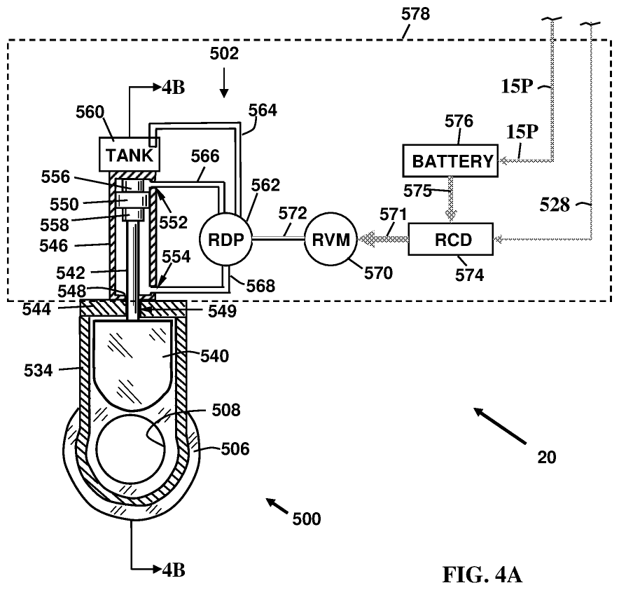

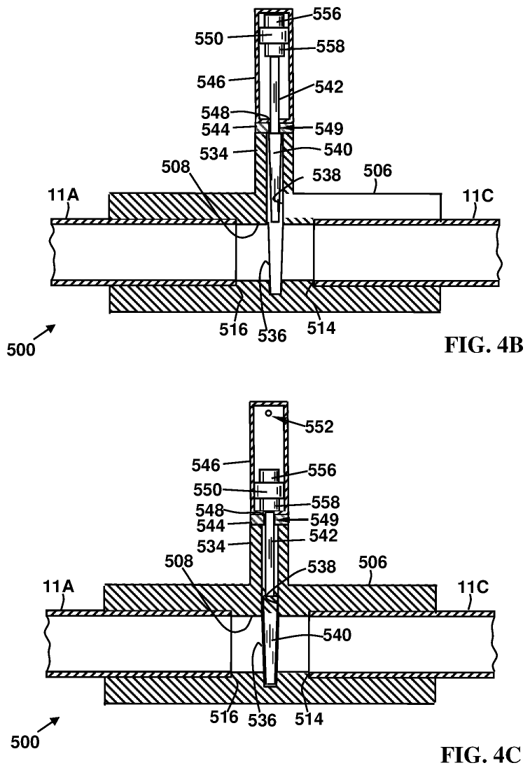

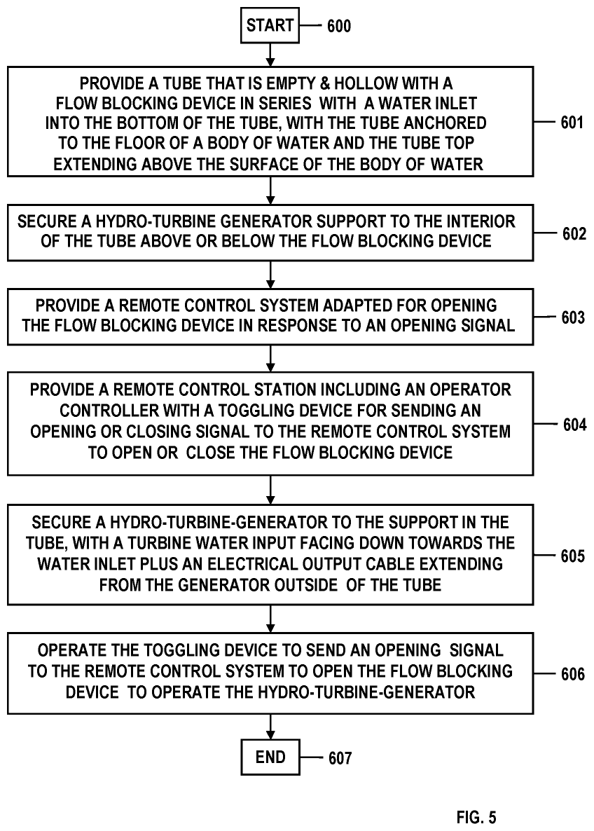

A simpler central station 29 is shown in FIG. 3 for the power tube 11A. The control valve system 20 in FIGS. 1, 2A and 2B includes a hydraulic control system 578 shown in FIG. 4A which operates a gate valve 500 shown in FIG. 4A which blocks water flow initially, prior to energizing the hydro-turbine, electric generator 43 with high-pressure water 9.

Referring to FIGS. 1, 2A and 2B, when power is to be generated by the hydro-turbine, electric generator 43 the gate 540 of gate valve 500 (FIGS. 4A-4C) is opened under the control of the hydraulic control system 578, thereby allowing rapid flow of water 9 from the convergent, tubular, nozzle 12 into the power tube 11 to power the hydro-turbine, generator 43 which produces electrical power.

A simpler central station 29 is shown in FIG. 3 for energizing the hydro-turbine, electric generator 43 in power tube 11A.

Referring again to FIGS. 1, 2A and 2B, the opening(s) 120 to the convergent, tubular, nozzle 12 is/are controlled by one or a plurality of optional, lower level, access valve(s) 25, which are shown in the closed positions in FIG. 1, but in the open positions in FIGS. 2A and 2B. Valves 25 are shown in the open position in FIG. 2 to admit water into the convergent, tubular, nozzle 12 at a time prior to operating the hydro-turbine, generator 43 to provide maximum initial power.

At the bottom of the nozzle 12, throats 12T are shown in FIGS. 1, 2A and 2B which are adapted to introduce water under high pressure via the convergent, tubular, nozzle 12 into the bottom 11B of the lower segment 11L of the power tube 11 to power the hydro-turbine generator 43. The throats 12T can be constructed to provide anchoring, support, and stability to the power generating system as described below with reference to FIG. 2.

In summary, the convergent, tubular, nozzle 12 which comprises a water jet is adapted to supply water from a fluid collection system comprising the opening(s) 120, the U-turn throat(s) 12T, and the convergent, tubular structure 12C. Fluid flowing through the opening(s) 120 is adapted to be controlled by the optional, lower level, access valve(s) 25. The access valve(s) 25 can be closed when water is being evacuated from the power tube 11 in preparation for reuse of the system to generate more power when required.

The throats 12T are provided for introducing the water under fluid pressure into the bottom 11B of the lower segment 11L of the power tube 11 to power the hydro-turbine generator 43. The opening(s) 120 to the convergent, tubular, nozzle 12 are adapted to be controlled by one or a plurality of lower level, access valve(s) 25 which are shown in the normally-open position to admit water into the convergent, tubular, nozzle 12 prior to powering the generator. Additionally, the convergent, tubular, nozzle 12 includes throats which can be constructed to provide anchoring, support, and stability to the power generating system 10.

The central station 28 also includes an operator control switch (E) 28E for controlling access valve(s) 25 at openings 120 for supplying water under pressure through a convergent, tubular, nozzle 12 into to the bottom 11B of the power tube during the generation power by the hydro-turbine generator 43, as described in more detail below.

FIGS. 2A, 2B and 3 are schematic drawings which show modifications of the power generating system 10 of FIG. 1 partially immersed in a body of water 9. The power generating system 10 contains the hydro-turbine generator 43 in the power tube 11.

In the case of FIGS. 2A and 2B, the hydro-turbine generator 43 is shown in the power tube 11 after the control valve system 20 has been opened to allow deep water pressure to generate electricity.

The power generating system 10 of FIG. 1 includes a hollow platform 27, located above the water surface 9S and affixed to the top of the upper segments of the power tube 11. The power tube 11 is elongated, hollow, and extends vertically. Segments of power tube 11 are indicated by the segmented sidelines thereof including both upper 11U and lower 11L cylindrical, tubular segments. The hollow, platform 27, which is integral with the power tube 11, includes a hollow, cylindrical, tubular, outlet channel 27S.

The power tube 11 is aligned with and combined with the hollow, cylindrical, tubular, outlet chamber 27S of the launch platform 27. The diameters of hollow, cylindrical, tubular spaces 11S and 27S are matched and aligned forming a combined vertical, hollow, cylindrical tubular chamber 11S/27S adapted for housing the hydro-turbine generator 43 of electricity. As shown in FIGS. 2 and 3 the power tube 11/11A, extends downwardly into the water 9 deep below the platform 27.

When the hydro-turbine generator 43 is being powered, water can pass therethrough with minimal impediment by passing up through the walls of the power tube 11 and walls of outlet chamber 27S in the platform 27 onto the surface of the body of water with minimal burden upon the water rising from the power tube 11 except for the minimal burden of atmospheric pressure. As shown in FIGS. 1 and 2, the power tube 11 has an upper end 11U and a lower end 11L. The lower end 11L includes a bottom 11B of the power tube 11.

As shown in FIGS. 1, 2A and 2B the hydro-turbine generator 43 is supported by and secured to support ring flanges 31 The support ring flanges 31 are in turn rigidly secured to the power tube 11/11A One support ring flange 31 is located above the hydro-turbine generator 43 and preferably secured thereto. Another support ring flange 31 is located below the hydro-turbine generator 43 and is rigidly secured to the bottom 11B of the power tube 11.

In summary, to retain the hydro-turbine generator 43 in a fixed position the support ring flanges 31 are rigidly secured to the inner walls of the power tube 11. Thus the hydro-turbine generator 43 and support ring flange 31 are secured near the bottom of 11B power tube 11 as shown in FIGS. 1, 2A and 2B, but located above the power tube valve 500.

The support ring flanges 31 and hydro-turbine generator 43 may be welded to the inner wall of the lower segment of the power tube 11 to provide the support required for the heavy, hydro-turbine generator 43 and to hold it in place.

The power tube control valve system 20 at the bottom 11B of the power tube 11 of FIGS. 1 and 2 includes the gate valve 500 shown in FIGS. 4A, 4B and 4C. Joined to the bottom 11B of the power tube 11 and integral therewith is a convergent, tubular, nozzle 12 for supplying water 9, under natural deep water pressure, to the power tube 11 during the power generating of the hydro-turbine generator 43.

The gate valve 500 is provided to close the bottom 11B of the lower segment 11L of the power tube 11 prior to launch thereby holding back hydrostatic water pressure from allowing water to flow through the convergent, tubular, nozzle 12 into the bottom 11B of the power tube 11. The gate valve 500 is shown in the pre-launch closed position in FIG. 4C as described below. During power generating of the hydro-turbine generator 43 illustrated by FIGS. 2 and 3, the gate valve 500 has been opened with the gate 540 retracted, as shown in FIGS. 4A and 4B.

To review, FIGS. 1 and 2 show the power tube 11 with the control valve system 20 at the bottom 11B of the power tube 11. The control valve system 20 includes the hydraulic control system 578, shown in FIG. 4A, which is actuated by remote control signal from the operator toggle device 28T to actuate closing of the gate valve 500 shown in FIGS. 4A, 4B and 4C prior to use of the system to generate power. In other words, prior to operation, the gate valve 500 is in the normally-closed position to prevent water from prematurely entering the bottom 11B of power tube 11.

Referring again to FIG. 1, at power initiation time the gate valve 500 in the power tube 11 control valve system 20 is opened in response to a remote control signal on lines 528 from the operator toggle device 28T in FIG. 1 which actuates the hydraulic control system 578 shown in FIG. 4A which opens the valve 500 to generate power.

The convergent, tubular, nozzle 12 which serves as a water jet is adapted to supply water from a fluid collection system comprising the opening(s) 120, the U-turn throat(s) 12T, and the convergent, tubular structure 12C.

Water flowing through the opening(s) 120 is adapted to be controlled by optional, lower level, normally-open, access valve(s) 25. While valve(s) 25 are closed in FIG. 1 and open in FIG. 2, they can be closed after completion of a cycle of power generation when water is being evacuated from the power tube 11 to prepare for the next cycle of power generation.

Prior to operation of control valve system 20 to admit water into power tube 11, the access valve(s) 25 shown in FIGS. 1-2 are preferably in the open position to permit water to enter the convergent, tubular, nozzle 12 through the opening(s) 120 and the U-turn throat(s) 12T.

Opening(s) 120, which may be one annular structure or separate structures, is/are formed as inlet(s) to the convergent, tubular, nozzle 12 to introduce water into the convergent, tubular, nozzle 12 flowing through the gate valve 500 in the power tube 11 via the control valve system 20 at the bottom 11B of power tube 11. The convergent, tubular, nozzle 12 is provided to accelerate the flow rate of water rushing therefrom into the power tube 11.

The opening(s) 120 to the convergent, tubular, nozzle 12 are controlled by one or a plurality of the optional, lower level, normally-open, access valve(s) 25 which are shown in the normally-open position to admit water into the convergent, tubular, nozzle 12 rapidly.

Referring again to FIG. 1, a central station 28 on or near the platform 27 contains a power supply 28P for supplying electrical power through cable 15P to node 15, through power supply cable 15L to operator toggle device 28T and through cable 15E to operator control switch (E) 28E. The operator toggle device 28T supplies valve control signals via control lines 528 to the control valve system 20 at the bottom of the power tube 11.

In addition, the power supply node 15 supplies power through cable 15P to the contacts of a normally-open, lower level control switch 22 which controls lower level access valve actuators 24 that are adapted, only when the contacts thereof are closed by operator activation of operator toggle device (E) 28E in central station 28, to supply power for closing the optional, normally-open, lower level access valves 25.

Referring to FIG. 4A, the control signals on control lines 528 connect to RCD 519 to open power tube gate valve 500 when it is closed.

In addition, referring to FIG. 1, the power supply node 15 supplies power through cable 22S to the contacts of a normally-open, lower level control switch 22 which controls lower level access valve actuators 24 that are adapted (only when the contacts thereof are closed) to supply power for closing the optional, lower level, normally-open, access valves 25.

The power supply 28P also supplies power via line 15P to control valve system 20 and an operator control switch (E) 28E located in the controller 28 which connects via line 22S.

To close the optional, normally-open, lower level the access valve(s) 25 the controller 28 also supplies switch signals from the operator nozzle evacuation control switch (E) 28E in the operator controller 28 which are sent on lower level cable 22S to close the normally-open lower level control switch (SW) 22. When normally-open SW switch 22 is closed, it sends power from node 15 through cable 15P via switch 22 and cables 23 to energize access valve actuator(s) 24 which close the lower level access valves 25, after power generation is completed and water 9 is being evacuated from the power tube 11 in preparation for the next operation of the power generating system 10.

To facilitate power generating the hydro-turbine generator 43, the hollow, tubular outlet chamber 27S and the aligned, congruent, hollow, tubular chamber 11S/27S do not contain water initially, but instead are both filled with lower density atmospheric air instead of higher density water to minimize resistance to acceleration. Joined to the bottom 11B of the power tube 11 and integral therewith is a convergent, tubular nozzle 12. The convergent, tubular, nozzle 12 is formed at the lower segment 11L of the power tube 11 with U-turn throat(s) 12T and opening(s) 120. Throat(s) 12T are provided for introducing water under deep water pressure (i.e. water at great depth) to into the lower segment 11L of the power tube 11 to operate the hydro-turbine generator 43 in the chamber 11S/27S of the power generating system 10.

In FIG. 1, the bottom 11B of power tube 11 is shown with the control valve system 20 with the gate valve 500 shown in FIG. 4B in the normally-closed position to prevent water from entering the bottom 11B of the power tube 11 prior to the start time for the hydro-turbine generator 43. The normally-closed, power tube, gate valve 500 is to be opened at start time by a hydraulic control system 578 shown in FIG. 4A.

In FIGS. 2A and 2B, the convergent, tubular, nozzle 12, which comprises a convergent, water pressure structure serving as a water jet, has opening(s) 120 with normally-open lower level, access valve(s) 25 shown in the normally-open position to permit water to enter the nozzle 12 through the opening(s) 120 and U-turn throats 12T which are connected to introduce water via a narrowing region 12C of the convergent tubular nozzle 12. The convergent tubular nozzle 12 introduces water via a narrowing region 12C and an inlet 121 below the normally-closed, power tube gate valve 500.

Opening(s) 120 which may be annular or separate structures formed on the convergent tubular, nozzle 12 serve to introduce water into the convergent tubular nozzle 12 flowing towards the power tube 11. The convergent, tubular, nozzle 12 is provided to accelerate the flow rate of water rushing therefrom into the power tube 11. The opening(s) 120 to the convergent, tubular, nozzle 12 are controlled by one or a plurality of lower level, access valve(s) 25 which are shown in the normally-open position to permit water to enter the nozzle 12.

In summary, until operation of the hydro-turbine generator 43 is to be initiated, the control valve system 20 keeps the normally-closed, power tube, gate valve 500 closed to block water flow into the lower segment 11L of power tube 11.

The operator controller 28 supplies electrical power on cable 15P to power source node 15. The normally-closed, power tube, gate valve 500 in the control valve system 20 can be opened by a signal on cable 528 from an operator toggle device (T) 28T operated by the user. Upon opening of normally-closed, power tube, gate valve 500, the valve(s) 25 water from the converging region 12C of the convergent, tubular nozzle 12 passes through inlet 121 into the bottom 11B of the power tube 11. That initiates operation of the hydro-turbine generator 43. With the power tube 11 installed in deep water, when the normally-closed, power tube, gate valve 500 opens, it will admit water at very high pressure into the bottom end 11B of the power tube 11 to start the hydro-turbine generator 43.

The convergent, tubular, nozzle 12 comprises a convergent, tubular structure serving as a water jet, with opening(s) 120 with normally-open lower level, access valve(s) 25 shown in the open position to permit water into the nozzle 12 through U-turn throats 12T.

Opening(s) 120 which may be annular or separate structures formed on the convergent, tubular, nozzle 12 serve to introduce water into the nozzle 12 flowing towards the power tube 11. The convergent, tubular, nozzle 12 is provided to accelerate the flow rate of water rushing therefrom into the power tube 11.

The opening(s) 120 to the convergent, tubular, nozzle 12 are controlled by one or a plurality of access valve(s) 25 which are shown in the normally-open position to admit water into the nozzle 12. As shown, the normally-open access valve(s) 25 can be closed by the access valve actuator(s) 24 which have been energized with power from power source node 15 delivered thereto through cable 21, switch 22 and cable 23. Switch 22 is adapted to be closed by a signal on cable 22S from nozzle evacuation switch 28E in the operator toggle device 28 to energize access valve actuator(s) 24 to close normally-open access valve(s) 25. T

The nozzle 12 includes U-turn throats 12T which are connected to introduce water via a wide opening into a converging region 12C of the convergent nozzle 12 which narrows from the U-turn throats 12T to power tube valve 500 of FIG. 4B in closed control valve system 20 is shown at the top of the convergent, tubular, nozzle 12. Prior to turning power on, the normally-closed, gate valve 500 is normally in the closed position to block water flow into the lower segment 11L of power tube 11 until operation of the hydro-turbine generator 43 is to be initiated.

FIG. 2 is a schematic drawing of the power generating system 10 of FIG. 1 which contains the hydro-turbine generator 43 rising off the support ring flange 31; and the power generating system 10 is at least partially immersed in a body of water 9, which may comprise an ocean, a sea, a reservoir or a lake, etc. The body of water 9 has a top surface 9S far above the bottom surface 8S of the body of water 9, on top of the floor 8F, which is located deep at the bottom of the body of water 9. As described above, the power generating system 10 of FIG. 2 includes the platform 27 on top combined to form the elongated, partially submerged power generating system 10 in the upright, vertically-extending, cylindrical, power tube 11.

As shown in FIGS. 2A and 2B most of the power generating system 10 is located in the body of water 9. The power tube 11, which extends a downwardly, has an upper segment 11U extending above the top surface 9S of the body of water 9. As stated above, both the platform 27 and the power tube 11 comprise the aligned, hollow, tubular chamber 11S and the hollow, tubular, outlet chamber 27S which are filled with atmospheric air above the hydro-turbine generator 43, prior to launch of the hydro-turbine generator 43. From the top launch platform 27 located above the top surface 9S of the body of water 9, the power generating system 10 extends vertically down towards the surface 8S of the floor 8F at the bottom of the body of water 9.

As shown in FIGS. 2A and 2B, below the top platform 27, the downwardly extending vertical power tube 11 has its upper segment 11U extending above the top surface 9S of the body of water 9 and its lower segment (11L) extending down near the surface 8S of the of the floor 8F of the deep body of water 9. That is to say that in FIGS. 2A, 2B and 3, below the top of its platform 27, almost all of the remainder of the complete power generating system 10 is immersed in the body of water 9.

The composition of the water floor 8F, below the upper surface 8S thereof, comprises material such as soil, sand, and/or pavement, etc. In FIGS. 2A and 2B, the power generating system 10 includes the power generating system 10 at the bottom end of the upright, vertically extending, power tube 11 and the top platform 27 filled with atmospheric air. The power tube 11 is built in one or more sections of strong durable and waterproof material.

The power generating system 10 shown in FIGS. 1-3 is adapted to operate the hydro-turbine generator 43 in the lower segment 11L of the power tube 11 with high pressure water flowing therethrough. The air filled power tube 11 extends vertically deep into the water 9 towards the surface of the deep floor 8F and is retained in the position shown in FIGS. 2A and 2B. 2 by anchor cables 32 that are secured to an anchor 8A which is located on the surface 8S on the water floor 8F.

The anchor 8A has sufficient weight to hold the power generating system 10 down against buoyancy forces and/or the anchor is secured to ledges deep in the floor 8F. When loaded with the hydro-turbine generator 43, the power tube 11 is adapted to power the hydro-turbine generator 43 contained therein preferably by positioning the upper segment 11U of the power tube 11 above the top surface 9S of the water 9 to retain air in power tube 11, thereby avoiding the drag on power generating the hydro-turbine generator 43 with the weight of water thereabove.

The hydro-turbine generator 43 is to be located proximate to the lower segment 11L of the empty power tube 11. The lower segment 11L of the power tube 11 is shown closed by remotely controlled, control valve system 20 so that the hydro-turbine generator 43 remains in position as the power tube 11 is protected from the high pressure water therebelow.

The air filled power tube 11 (when it is empty of water) is adapted to use the water pressure of the deep water being available to provide large water pressure forces which can drive the hydro-turbine generator 43 to produce a very high output of electric power.

Referring again to FIG. 1, a convergent tubular nozzle 12 is formed at the bottom 11B of the power tube 11. The convergent, tubular, nozzle 12 has inlets 121 with normally-open, access valve(s) 25 shown in the open position to permit water to enter the nozzle 12 through U-turn throats 12T. The access valve(s) 25 can be closed by the access valve actuators 24 which can be energized with power from power source node 15 through cable 21, normally-open switch 22 and cables 23.

The nozzle includes U-turn throats 12T which are connected to introduce water via a wide opening into a converging region 12C of the convergent nozzle 12 which narrows from the U-turn throats 12T to control valve system 20. The closed gate valve of control valve system 20 is shown at the top of the convergent, tubular, nozzle 12. The power tube valve 500 remains in the closed position to block water flow into the bottom end 11B of power tube 11 until power generating of the hydro-turbine generator 43 is to be initiated.

FIG. 3A is a schematic drawing of a plan view of an alternative embodiment in accordance with this invention comprising a power generating system 10A that is adapted to be at least partially immersed in a body of water. FIG. 3B is a section taken along line 3B-3B of FIG. 3A showing a modified power tube 11A which is rigidly supported partially below the surface of the water 9.

Referring to both FIGS. 3A and 3B, in order to provide rigid support for the modified power tube 11A, a set of rigid, horizontal struts 161, a plurality of erect, vertical columns 160 and a plurality of heavy, deep water footings 162 are provided.

The erect, vertical columns 160 are rigidly supported by deep water footings 162 buried in the surface 8S of the water floor 8F. Rigid, horizontal struts 161 between the modified power tube 11A and vertical columns 160 are affixed at inner ends to the modified power tube 11A and at distal ends to the vertical columns 160, as shown, holding modified power tube 11A, securely and rigidly in place.

In FIG. 3B, the hydro-turbine generator 43 is supported and secured in position by support ring flanges 31 of the kind shown in FIGS. 1, 2 and 2B as described above in detail.

In addition, the power tube 11A does not need to be formed in the circular configuration shown but may have many alternative cross sections. The power tube 11A is built with similar features to these of artillery cannon in that the inner walls of the power tube 11A can be smooth or rifled as desired.

The upper end of the chamber 11S/27S inside the power tube 11A can be sealed by a structure 27 (shown in phantom) near the top thereof for the purpose of creating a vacuum therein. The power tube 11A can be built with exhaust systems with plumbing and for pumping water or air out of the power tube chamber 11S/27S.

As will be well understood by those skilled in the art, such exhaust systems can be powered by a cable (not shown) from the electrical power supply (P) 29P shown in a modified, simpler control station 29.

Prior to turning power on, the neck 112 at the bottom of power tube chamber 11S is sealed by an explosive plug 131 located beneath the support ring flange 31. The explosive plug 131 provides a wedge sealing neck 112 at the lower end of the power tube chamber 11S in power tube 11A prior to ignition of explosive plug 131. Inwardly tapered interior walls 11T of the neck 112 to the power tube 11A extend from the bottom of the power tube 11A up to above the top of the explosive plug 131. The walls 11T are tapered, inwardly from bottom to top along the narrowing walls 11T of the power tube 11A for the purpose of concentrating in rushing water.

The wider surfaces of explosive plug 131 are jammed against the walls 11T to prevent the explosive plug 131 from sliding up prior to detonation of explosive plug 131. The explosive plug 131 has sufficient rigidity and strength to resist significant pressures from the deep water 9. The explosive plug 131 is adapted to be ignited by the detonator 132 connected by the cable 130 to electrical power, as explained in detail below.

Upon ignition of the explosive plug 131, the explosion of the explosive plug 131 and water pressure released from below the hydro-turbine generator 43, although the explosive may be limited to only collapsing the explosive plug 131 thereby allowing deep water pressure to inrush into the power tube 11A. The detonator 132 is similar to those of the type shown in U.S. Pat. No. 3,580,171.

While the explosive plug 131 is shown with a spherical shape it may have alternative shapes adapted to plug into the lower end of the interior, tubular chamber 11S of the power tube 11A, so that prior to ignition thereof, its exterior surface forms a water tight plug with the interior walls 11T of the tubular space in power tube 11A.

The detonation of the explosive plug 131 is controlled by firing control (L) switch 30L as an actuation device, which receives electrical power from electrical power supply (P) 29P by connections described below. Power is also supplied from power supply (P) 29P via cable 15P to a normally-open electrical switch 122. When activated by the operator, the firing control (L) switch 30L supplies a control signal on cable 17S which closes switch 122 thereby supplying electrical power via cable 130 to the detonator 132, causing detonator 132 to fire. Then, as a result of the firing of the detonator 132, the explosive plug 131 is detonated creating an explosion, which opens the neck 112 so that the water pressure entering the neck 112 create forces that power the hydro-turbine generator 43.

An advantage of the present invention is that it provides a renewable, non-polluting source of energy.

The chamber can have several variations in configuration depending on the requirements for structural stability. Preferably, the chamber has been described as being cylindrical but can have other shapes, but preferably the chamber is straight. The system is capable of submersion in a body of water and is strong enough to withstand forces of rapid buildup. Preferably, the power generating system is sturdy, durable, and reusable. The inner surface of the chamber can be grooved or smooth. The chamber may be lined with an internal sleeve, which can be used to adjust the inner dimension of the chamber so that hydro-turbine generators of varying sizes can be employed The chamber can be pre-manufactured with plumbing for evacuation of the water from the power tube 11/11A.

The chamber can be manufactured or constructed with built-in wiring for power control of the post operation evacuation valves. A wide range of commercial valves are available, and the valves can be standard mechanical valves mechanically activated as an alternative to the above described embodiment of the present invention. Alternatively, explosive valves are preferred implementation for [producing very fast influx of water and/or pressure as shown in FIGS. 4A and 3B. Valves may also be activated by gasoline, propane gas an alternative to electrically controlled valves.

Cylindrical or alternatively shaped tube construction can be employed. Because of the strength requirements and straightness required much care is required in the construction of such tubes. It is envisioned to be a single piece construction with provision for on shore construction and subsequent floating to a launch site. Sectional construction is possible.

FIG. 4A is a sectional elevational view of the hydraulic, control valve system 20 of FIG. 1 with the gate 540 of a gate valve 500 shown in the open position and the hydraulic control system 578 depicted schematically.

FIG. 4B is a view taken on line 4B-4B of FIG. 4A showing the gate 540 of the gate valve 500 shown in the open position.

FIG. 4C is a view of a modification of FIG. 4B showing the gate 540 of the gate valve 500 shown in the closed position.

The hydraulic gate valve 500 which is operated by remote control is installed in the power tube 11 as described above. Alternate remote open and close control signals selectively open the hydraulic gate valve 500 for fluid flow or close the gate valve 500 thereby blocking fluid flow through the power tube 11.

The hydraulic gate valve 500 in the tube 11 and has a gate 540 connected to a hydraulic piston 550 which can open and close the gate valve 500. The direction of flow of hydraulic fluid into the piston chamber 546 is controlled by a ReVersible (RVM) motor 570 which may be actuated from the operator toggle device 28T in the central station 28 whereby the hydraulic fluid may be directed to drive the valve stem 542 in one direction for closing of the gate valve 500, and in a reverse direction for opening of the gate valve 500.

The gate valve 500 is connected above the nozzle 12 in series in the power tube 11 above the convergent, tubular, nozzle 12 for selectively controlling by allowing and/or preventing the flow of fluid therethrough. The gate 540 of the hydraulic gate valve 500 is fastened to the valve stem 542 which is connected with a piston 550 disposed for reciprocal movement within the piston chamber 546 for hydraulic fluid. Means is provided for directing hydraulic fluid into the piston chamber 546 for acting against one end of the piston in order to open the gate valve 500 to permit a free flow of fluid therethrough, and for alternately directing the hydraulic fluid to the opposite end of the piston 550 in order to close the gate valve 500, thereby blocking the flow of hydraulic fluid through the power tube 11. The fluid control means comprises a suitable Reversible Drive Pump (RDP) 562 driven by the RVM 570 which is powered by a long life battery 576, with the actuation of the motor RVM 570 being under remote control from 28.

Referring to FIGS. 4A and 4B in detail, the control valve system 20 is provided for controlling by opening and/or closing of the hydraulic gate valve 500 by a hydraulic valve control system 578. The hydraulic gate valve 500, as shown herein comprises a main body 506 of substantially cylindrical configuration having a central bore 508 extending longitudinally therethrough to provide a fluid passageway and a gate 540 shown in FIGS. 4B and 4C retracted to an open position.

The gate 540 is provided to close the gate valve 500 prior to launch of the hydro-turbine generator 43 and to open at launch time in response to closing and opening signals respectively from the operator toggle device 28T in FIG. 1.

Whereas the gate valve 500 may be interposed in a hollow, power tube 11 in any suitable manner, as particularly shown herein, the ends 11A and 11C of adjacent power tube 11C are shown inserted within and fastened to opposite ends of the central bore 508 of the main body 506 of gate valve 500 for interposing the hydraulic gate valve 500 in the hollow, power tube 11/11A.

Oppositely disposed longitudinally spaced annular shoulder 514 and annular shoulder 516 are provided in the central bore 508 for receiving the power tube section 11A and power tube section 11C, respectively, shown pressed thereagainst for limiting the longitudinal insertion of the power tube sections within the main body 506 of the gate valve 500.

FIGS. 4A, 4B and 4C show the main body 506 of the hydraulic gate valve 500 with a sleeve 534 that is integral with extending at right angles from the main body 506. FIGS. 4B and 4C show both a recess 536 which is of tapered, annular configuration provided in the main body 506 which is in open communication at 538 in FIGS. 4B and 4C with the interior of the sleeve 534.

The recess 536 is preferably of a tapered, wedge shaped cross-sectional configuration in a plane taken along the longitudinal axis of the main body 506, as best shown in FIG. 4C, for a purpose set forth below. A gate 540 (which is also tapered with a substantially wedge shaped cross-sectional configuration complementary to the tapered, configuration of the recess 536) is reciprocally disposed within the sleeve 534 so that it may be alternately lowered and raised within the sleeve 534 and across the central bore 508 of the main body 506, as viewed in the drawings.

As shown in FIG. 4B, in the lowered position of the gate 540, the gate 540 is disposed across the opening of the central bore 508 of the hydraulic gate valve 500 to preclude passage of fluid through the hydraulic gate valve 500. As shown in FIG. 4C, in the raised position of the gate 540, the gate 540 is lifted up to remove it from the central bore 508 to permit the free passage of fluid therethrough. The gate 540 is attached to a reciprocal valve stem 542 which extends axially outwardly from the sleeve 534 through an aperture 549 in cover 544 which is secured to the outer end of the sleeve 534.

In addition, suitable sealing means (not shown) is preferably interposed between the cover 544 and the sleeve 534 for precluding leakage of fluid therebetween, and further sealing means may preferably be interposed between the cover 544 and the reciprocal valve stem 542 for precluding leakage of fluid therebetween as will be well understood by those skilled in the art.

A fluid piston chamber 546 for hydraulic fluid is disposed above the cover 544 and is secured thereto. The housing 546 is provided with an aperture 548 in the surface thereof aligned with the aperture 549 and juxtaposed above the cover 544 for receiving the reciprocal valve stem 542 therethrough. Conventional sealing means (not shown) is preferably provided between the piston chamber 546 and reciprocal valve stem 542 for precluding leakage of hydraulic fluid therefrom.

A suitable piston 550 is provided on the reciprocal valve stem 542 and reciprocally disposed within the housing 546. A first port 552 is provided in the proximity of a first, upper end of the piston chamber 546, and a second port 554 is provided in the proximity of the lower, opposite end of the piston chamber 546.

The piston 550 is reciprocated between opposite ends of the piston chamber 546 by hydraulic fluid pressure within the piston chamber 546. Suitable stop means 556 is provided on the first, upper end of the piston 550 for limiting the movement thereof in the opened direction, and second stop means 558 is provided on the opposite, lower end of the piston 550 for limiting the movement thereof in the opposite, closed direction.

Referring to FIG. 4A, a hydraulic fluid reservoir 560 is connected via hydraulic fluid supply conduit 564 to supply fluid to a Reversible Drive Pump (RDP) 562. The reversible drive pump 562 is connected at opposing ports thereof to drive the piston 550 in the piston chamber 546 via valve closing port 552 and valve opening port 554 through suitable hydraulic fluid supply valve closing conduit 566 and valve opening conduit 568 respectively.

The reversible drive pump 562 is connected to be driven by a suitable ReVersible Motor (RVM) 570 by drive shaft 572. The RVM 570 is operably connected to control the reversible drive pump 562 to operate the hydraulic gate valve 500 by driving the piston 550 up or down to open and close the gate 540 of the hydraulic gate valve 500 by a Remote Control Device (RCD) 574. Operator toggle device 28T in FIG. 1 sends control signals to the RCD 574 via control lines 528.

In addition, referring again to FIG. 4A the control signals pass through control lines 528 to the distal end of control lines 528 which are directly connected to the control input of RCD 574.

Alternatively, control of the RCD 574 may be provided by a radio frequency control system (not shown) as will be well understood by those skilled in the art.

In addition, the hydraulic valve control system 578 is operably connected with a suitable power source, such as a long life battery 576 which is connected to an external power supply by cable 15P from node 15B.

The hydraulic fluid reservoir 560, reversible drive pump 562, RVM 570, the RCD 574 and battery 576 and the piston chamber 546 for the piston 550 which opens and closes the gate 540 of the hydraulic gate valve 500 are all installed within hydraulic valve control system 578 of the control valve system 20.

The hydraulic gate valve 500 and its ancillary hydraulic control system 502 are installed in the power tube 11 in order to provide selective flow control of fluid passing through the power tube 11/11A. The hydraulic gate valve 500 is preferably installed between adjacent power tube sections as hereinbefore set forth, and it is preferable to install the hydraulic gate valve 500 in such a manner that the gate 540 is in a normally open position as shown in FIGS. 4A and 4B.

It will be apparent that suitable sealing means (not shown) may be provided between the gate 540 and the recess 536 in order to preclude leakage of fluid therebetween, or the gate member may provide a metal to metal seal with the body 506, as is well known. In order to raise the gate 540 to the open position, the reversible drive pump 562 is activated in any well known manner for directing hydraulic fluid from the reservoir 560 into the piston chamber 546 through the port 554 below the piston 550. The hydraulic fluid pressure acting on the lower surface of the piston 550 urges the piston 550 upwardly, thus forcing any hydraulic fluid in the piston chamber 546 thereabove to be discharged through the port 552 and directed back into the hydraulic fluid tank 560.

The hydraulic fluid may be retained in the piston chamber 548 below the piston 550 in the usual manner for maintaining the piston 550 in the open position shown in FIG. 4B. The hydraulic gate valve 500 may remain in the open position, or until such time as it is required to close the hydraulic gate valve 500 for shutting down fluid flow between the convergent, tubular, nozzle 12 and the power tube 11.

When it is desired to close the gate 540 of the hydraulic gate valve 500, a control signal is sent to the hydraulic control system 502 of FIG. 4A in the control valve system 20 from the operator toggle device 28T on control line 528 shown in FIGS. 1 and 4A. The RCD 574 may thus be activated properly for operation of the RVM 570, which in turn actuates the reversible drive pump 562 for properly controlling the flow of the hydraulic fluid to and from the piston chamber 546.

In order to close the hydraulic gate valve 500, the reversible drive pump 562 is actuated for directing the hydraulic fluid into the piston chamber 546 through the port 552 above the piston 550, while simultaneously withdrawing the hydraulic fluid from the port 554 below the piston 550.

Of course, the hydraulic fluid pressure acting on the upper end of the piston 550 urges the piston 550 downwardly in the piston chamber 546 for moving the gate 540 downwardly to the position shown in FIG. 4B, thus closing the tube 11 and precluding the flow of hydraulic fluid through the hydraulic gate valve 500. The hydraulic fluid withdrawn from the lower portion of the piston chamber 546 may be either transferred to the upper portion thereof, or may be returned to the hydraulic fluid reservoir 60, as desired. Of course, the pressure may be maintained on the upper end of the piston 550 indefinitely to retain the gate 540 in the closed position.

When it is desired to reopen the control valve system 20, the control device 574 may again be activated by a suitable signal from the operator toggle device 28T in FIG. 1 whereby the operation of the motor and the reversible drive pump 562 are reversed for reversing the flow of the hydraulic fluid to and from the piston chamber 546 in order to raise the piston 550, thus raising the gate 40 540 to the open position thereof.

Of course, it will be apparent that a suitable control panel (not shown) may be provided at the main control area having lights or other indicating devices whereby a visual inspection of the panel will disclose any malfunction at any of the control valve system 20 sites. When such a malfunction occurs, a suitable maintenance crew may be sent to the particular location for correcting the malfunction. Otherwise, the may be controlled for opening and closing of the tube 11 from the main control area with very little actual manual attendance at the site of the valves.

Method of Launch of Means for Generating Electricity from Power Tubes

In step 600, start the power generating process for the power generating systems 10/10A.

In step 601 provide an empty hollow, power tube 11/11A with a flow blocking device 500/131 in series with a water inlet 12/112 into the bottom of the power tube 11/11A. The power tube 11/11A is anchored in a body of water 9 deep enough to provide high pressure from the body of water 9. The tube top extends above the surface of the water.

In step 602 secure a hydro-turbine generator support 31 to the interior walls of the power tube 11/11A above or below a flow blocking device 500/131.

In step 603 provide a remotely controlled, control valve system 20 or detonator 132 adapted for opening the flow blocking device 500/131 in response to an opening signal.

In step 604 provide a remote control station 28/29 including an operator controller toggle device 28T/switch 30L for sending an opening or closing signal to the remotely controlled, control valve system 20 or detonator 132 to open the flow blocking device 500/131 or close device 500.

In step 605 load and secure a hydro-turbine generator 43 onto the hydro-turbine generator support 31 in the empty hollow power tube 11/11A with a after turbine input facing down towards the water inlet plus an electrical output cable extending from the generator outside of the tube.

In step 606 operate the operator toggle device 28T/switch 30L to send an opening signal to the remotely controlled control valve system 20 or detonator 132 thereby opening the flow blocking device 500/131 and supplying water pressure to power generate power with the hydro-turbine generator 43 from the power tube 11/11A.

In step 607 the steps of the method end.

Whereas the present invention has been described in particular relation to the drawings attached hereto, it should be understood that other and further modifications, apart from those shown or suggested herein, may be within the spirit and scope of this invention.

What is claimed is:

1. A method for generating electricity with water pressure from a body of water, which has a top surface and a bottom surface, by the steps comprising:
providing a power tube having an inside wall, an outside wall, a tube top and a tube bottom from the body of water with the power tube housing a hydro-turbine generator for generating electricity located inside the tube;
providing an inlet at the tube bottom and an outlet open at the tube top;
providing a flow blocking device at the inlet operable by remote control signals;
providing an actuation device for sending the remote control signals to control the flow blocking device;
installing the tube in the body of water with the tube top extending above the top surface, and with the tube bottom located deep in the body of water below the top surface; and
operating the actuation device for sending a remote control signal to open the flow blocking device;
whereby the hydro-turbine generator generates electricity.

2. The method of claim 1 including providing a support secured below the hydro-turbine generator to inside walls of the tube for supporting the hydro-turbine generator above the flow blocking device.

3. The method of claim 1 including anchoring the power tube to the bottom surface and thereby providing means for supporting the power tube in the body of water.

4. The method of claim 1 including providing a power supply for both the flow blocking device and the actuation device.

5. The method of claim 1 wherein the flow blocking device comprises a gate valve for controlling flow of water into the tube.

6. The method of claim 5 wherein the gate valve is operated to open and close by a hydraulic system.

7. The method of claim 5 wherein power is supplied to the flow blocking device by a cable for actuation thereof.

8. The method of claim 5 wherein remote control lines connect the actuation device to the flow blocking device for providing power thereto for actuation thereof.

9. A device for generating electricity with water pressure from a body of water having a top surface and a bottom surface comprising:
a power tube having an inside wall, an outside wall, a tube top and a tube bottom from the body of water with the power tube housing a hydro-turbine generator for generating electricity located inside the tube;
an inlet at the tube bottom and an outlet open at the tube top;
a flow blocking device at the inlet operable by remote control signals;
an actuation device for sending the remote control signals to control the flow blocking device;
the tube being installed in the body of water with the tube top extending above the top surface, and with the tube bottom located deep in the body of water below the top surface; and
the actuation device being adapted to send a remote control signal to open the flow blocking device;
whereby the hydro-turbine generator generates electricity.

10. The device of 9 including a support secured below the hydro-turbine generator to inside walls of the launching tube for supporting the hydro-turbine generator above the flow blocking device.

11. The device of claim 9 including means for anchoring the launching tube to the bottom surface and thereby providing means for supporting the launching tube in the body of water.

12. The device of claim 9 including a power supply for both the flow blocking device and the actuation device.

13. The device of claim 9 wherein the flow blocking device comprises a gate valve or explosive seal/plug.

14. The device of claim 13 wherein the gate valve is operated by a hydraulic system or electric system.

15. The device of claim 9 wherein power is supplied to the flow blocking device by a cable.

16. The device of claim 9 wherein remote control lines connect the actuation device to the flow blocking device.
